(19) United States
(12) Patent Application Publication
(10) Pub. No.: US 2009/0070847 A1
(43) Pub. Date: Mar. 12, 2009

(54) Positioning with Time Sliced Single Frequency Networks

(75) Inventors: Scott Furman, Menlo Park, CA (US); David Burgess, Fairfield, CA (US); Guttorm Opshaug, Menlo Park, CA (US)

Correspondence Address: LAW OFFICE OF RICHARD A. DUNNING, JR., 343 SOQUEL AVENUE, SUITE 311, SANTA CRUZ, CA, 95062, US

(73) Assignee: Rosum Corporation, Mountain View, CA (US)

(21) Appl. No.: 12/168,141

(22) Filed: Jul. 6, 2008

Related U.S. Application Data
(60) Provisional application No. 60/948,378, filed on Jul. 6, 2007.

(51) Int. Cl. H04N 7/173

(52) U.S. Cl. 725/131

(57) ABSTRACT

Apparatus having corresponding methods and computer-readable media comprise an input circuit to receive a transport stream of data, wherein the transport stream has periodic synchronization boundaries; a signal generator to provide a ranging signal, wherein the ranging signal represents a transmitter identifier; and a ranging time slice inserter to insert ranging time slices into the transport stream, wherein each ranging time slice is inserted into the transport stream at the same predetermined offset from a respective one of the periodic synchronization boundaries, and wherein each ranging time slice includes the ranging signal.

### CROSS-REFERENCE TO RELATED APPLICATIONS

This application claims benefit of U.S. Provisional Patent Application Ser. No. 60/948,378 filed Jul. 6, 2007, the disclosure thereof incorporated by reference herein in its entirety.

### BACKGROUND

The present invention relates generally to positioning. More particularly, the present invention relates to positioning with time sliced single-frequency networks.

Positioning receivers that are based on time-of-flight, such as GPS receivers, rely on extremely precise measurements of signal arrival times from multiple transmitter sites. Each relative time-of-flight measurement, when combined with the propagation speed of the signal and precise knowledge of transmitter positions, represents a constraint on the possible receiver location. An estimate of position can be formed by combining several such constraints.

This approach to positioning has been considered either unfeasible or, at least, extremely challenging for broadcast transmissions that use single-frequency network (SFN) technology, such as typical with Digital Video Broadcasting (DVB), Integrated Services Digital Broadcasting-Terrestrial (ISDB-T), Digital Audio Broadcasting (DAB), and Advanced Television Systems Committee Mobile/Handheld (ATSC-M/H) networks. In an SFN network, geographically dispersed transmitters emit time-synchronized replica signals. Hence, the signals arriving from different towers are not distinguishable, and it is not straightforward to associate the arrival of particular quanta of signal energy with any particular transmitter site.

The situation is made even more difficult by multipath, in which a signal may reflect and refract as it transits to the receiver along many different paths, each of which may overlap and either cancel or obscure the arrivals of weaker signals from other transmitters.

Another obstacle to positioning for all SFNs is high near-far ratios. That is, the ratio of received power from different transmitters may be extreme. Since all transmitters share the same frequency in an SFN, a high near-far ratio makes it difficult for receivers to reject a strong signal in favor of a weaker one. A consequence of the near-far effect is that the weaker signals may not be detected and hence not used for ranging, or may suffer increased ranging errors. In the limit, this effect can prevent positioning altogether, as a single very “loud” signal can drown out all others. The better a receiver system is at rejecting near-far effects, the larger the potential coverage area of the positioning system.

As the nomenclature suggests, near-far effects frequently occur due to the path loss difference between a distant and nearby transmitter. Large near-far ratio can also be the result of anisotropic building attenuation, fading, or differences in transmitter effective radiated power (ERP). Even GPS, despite near-uniform outdoor power flux, can suffer from high near-far ratio due to the differential attenuation of signals from different satellites when indoors.

Some SFN standards have defined “watermark” overlay signals intended for ranging and/or channel characterization. These overlay signals are transmitted in synchrony with the main signal, but at far lower power levels. For example, the ATSC A/110 standard defines a 64K-chip 2-VSB Kasami sequence that can be “buried” between 21 and 39 dB below the main 8-VSB signal. To a receiver attempting to demodulate the main signal, such a buried signal has an effect similar to Gaussian noise and, if buried sufficiently, will have no significant effect on the reception characteristics of the main signal. A receiver that is ranging from the watermark correlates against the Kasami reference sequence, taking advantage of the consequent processing gain to reduce the interference caused by the main 8-VSB signal.

Though watermark-style signals can be used for positioning, they are not effective in environments with even moderate near-far ratio. For example, consider an A/110-compliant SFN signal in which the watermark has been buried by 30 dB. One cycle of the Kasami code has a processing gain of log(216−1)=48 dB. Assuming that 13 dB SNR is the minimum required for accurate peak classification and ranging, and assuming 17 dB of integration (˜0.3 s) is employed to reduce the interference created by the stronger 8-VSB signal, a usable dynamic range of only 48−30−13+17=22 dB remains. That is, if the stronger signal is just 22 dB more powerful than the weaker one as measured at the receiver, ranging won't be possible from the weaker signal. In real-life scenarios with terrestrial transmitters, near-far ratios can exceed that value by a factor of 1000 or more.

### SUMMARY

In general, in one aspect, an embodiment features an apparatus comprising: an input circuit to receive a transport stream of data, wherein the transport stream has periodic synchronization boundaries; a signal generator to provide a ranging signal, wherein the ranging signal represents a transmitter identifier; and a ranging time slice inserter to insert ranging time slices into the transport stream, wherein each ranging time slice is inserted into the transport stream at the same predetermined offset from a respective one of the periodic synchronization boundaries, and wherein each ranging time slice includes the ranging signal.

Embodiments of the apparatus can include one or more of the following features. In some embodiments, the transport stream includes a plurality of program time slices each associated with one of a plurality of program identifiers, wherein the program time slices associated with a predetermined one of the program identifiers occur at the predetermined offset from the periodic synchronization boundaries; and wherein the ranging time slice inserter replaces the program time slices associated with the predetermined one of the program identifiers with the ranging time slices. In some embodiments, the transport stream is a Digital Video Broadcasting-Handheld (DVB-H) transport stream; and wherein the periodic synchronization boundaries are DVB-H megaframe boundaries. In some embodiments, the ranging signals comprise at least one of: DVB-H cyclic prefixes; DVB-H scattered pilot signals; and DVB-H continuous pilot signals. In some embodiments, the ranging signal includes a pseudorandom sequence; and wherein the pseudorandom sequence represents the transmitter identifier. Some embodiments comprise a modulator comprising the apparatus. Some embodiments comprise a transmitter comprising the modulator, wherein the transmitter is associated with the transmitter identifier.

In general, in one aspect, an embodiment features an apparatus comprising: input means for receiving a transport stream of data, wherein the transport stream has periodic synchronization boundaries; signal generator means for providing a ranging signal, wherein the ranging signal represents a transmitter identifier; and ranging time slice inserter means for inserting ranging time slices into the transport stream, wherein each ranging time slice is inserted into the transport stream at the same predetermined offset from a respective one of the periodic synchronization boundaries, and wherein each ranging time slice includes the ranging signal.

Embodiments of the apparatus can include one or more of the following features. In some embodiments, the transport stream includes a plurality of program time slices each associated with one of a plurality of program identifiers, wherein the program time slices associated with a predetermined one of the program identifiers occur at the predetermined offset from the periodic synchronization boundaries; and wherein the ranging time slice inserter means replaces the program time slices associated with the predetermined one of the program identifiers with the ranging time slices. In some embodiments, the transport stream is a Digital Video Broadcasting-Handheld (DVB-H) transport stream; and wherein the periodic synchronization boundaries are DVB-H megaframe boundaries. In some embodiments, the ranging signals comprise at least one of: DVB-H cyclic prefixes; DVB-H scattered pilot signals; and DVB-H continuous pilot signals. In some embodiments, the ranging signal includes a pseudorandom sequence; and wherein the pseudorandom sequence represents the transmitter identifier. Some embodiments comprise modulator comprising the apparatus. Some embodiments comprise transmitter comprising the modulator, wherein the transmitter is associated with the transmitter identifier.

In general, in one aspect, an embodiment features a method comprising: receiving a transport stream of data, wherein the transport stream has periodic synchronization boundaries; providing a ranging signal, wherein the ranging signal represents a transmitter identifier; and inserting ranging time slices into the transport stream, wherein each ranging time slice is inserted into the transport stream at the same predetermined offset from a respective one of the periodic synchronization boundaries, and wherein each ranging time slice includes the ranging signal.

Embodiments of the method can include one or more of the following features. In some embodiments, the transport stream includes a plurality of program time slices each associated with one of a plurality of program identifiers, wherein the program time slices associated with a predetermined one of the program identifiers occur at the predetermined offset from the periodic synchronization boundaries; and wherein inserting the ranging time slices into the transport stream includes replacing the program time slices associated with the predetermined one of the program identifiers with the ranging time slices. In some embodiments, the transport stream is a Digital Video Broadcasting-Handheld (DVB-H) transport stream; and wherein the periodic synchronization boundaries are DVB-H megaframe boundaries. In some embodiments, the ranging signals comprise at least one of: DVB-H cyclic prefixes; DVB-H scattered pilot signals; and DVB-H continuous pilot signals. In some embodiments, the ranging signal includes a pseudorandom sequence; and wherein the pseudorandom sequence represents the transmitter identifier.

In general, in one aspect, an embodiment features a computer-readable media embodying instructions executable by a computer to perform a method comprising: receiving a transport stream of data, wherein the transport stream has periodic synchronization boundaries; providing a ranging signal, wherein the ranging signal represents a transmitter identifier; and inserting ranging time slices into the transport stream, wherein each ranging time slice is inserted into the transport stream at the same predetermined offset from a respective one of the periodic synchronization boundaries, and wherein each ranging time slice includes the ranging signal.

Embodiments of the computer program can include one or more of the following features. In some embodiments, the transport stream includes a plurality of program time slices each associated with one of a plurality of program identifiers, wherein the program time slices associated with a predetermined one of the program identifiers occur at the predetermined offset from the periodic synchronization boundaries; and wherein inserting the ranging time slices into the transport stream includes replacing the program time slices associated with the predetermined one of the program identifiers with the ranging time slices. In some embodiments, the transport stream is a Digital Video Broadcasting-Handheld (DVB-H) transport stream; and wherein the periodic synchronization boundaries are DVB-H megaframe boundaries. In some embodiments, the ranging signals comprise at least one of: DVB-H cyclic prefixes; DVB-H scattered pilot signals; and DVB-H continuous pilot signals. In some embodiments, the ranging signal includes a pseudorandom sequence; and wherein the pseudorandom sequence represents the transmitter identifier.

In general, in one aspect, an embodiment features an apparatus comprising: a receiver to receive a wireless signal, wherein the wireless signal represents a transport stream of data, wherein the transport stream has periodic synchronization boundaries, and wherein the transport stream includes a plurality of ranging time slices each occurring at the same predetermined offset from a respective one of the periodic synchronization boundaries, and wherein each of the ranging time slices includes a ranging signal; and a range module to determine a pseudorange between the apparatus and the transmitter of the wireless signal based on the ranging signal.

Embodiments of the apparatus can include one or more of the following features. In some embodiments, the transport stream is a Digital Video Broadcasting-Handheld (DVB-H) transport stream; and wherein the periodic synchronization boundaries are DVB-H megaframe boundaries. In some embodiments, the ranging signals comprise at least one of: DVB-H cyclic prefixes; DVB-H scattered pilot signals; and DVB-H continuous pilot signals. In some embodiments, a location of the apparatus is determined based on the pseudorange between the apparatus and the transmitter of the wireless signal. In some embodiments, the ranging signal represents a transmitter identifier associated with a transmitter of the wireless signal, and wherein the apparatus further comprises: a transmitter location module to determine a location of the transmitter of the wireless signal based on the transmitter identifier; and a position module to determine a location of the apparatus based the location of the transmitter of the wireless signal and the pseudorange between the apparatus and the transmitter of the wireless signal. In some embodiments, the ranging signal includes a pseudorandom sequence; and wherein the pseudorandom sequence represents the transmitter identifier.

In general, in one aspect, an embodiment features an apparatus comprising: receiver means for receiving a wireless signal, wherein the wireless signal represents a transport stream of data, wherein the transport stream has periodic synchronization boundaries, and wherein the transport stream includes a plurality of ranging time slices each occurring at the same predetermined offset from a respective one of the periodic synchronization boundaries, and wherein each of the ranging time slices includes a ranging signal; and range means for determining a pseudorange between the apparatus and the transmitter of the wireless signal based on the ranging signal.

In some embodiments, the transport stream is a Digital Video Broadcasting-Handheld (DVB-H) transport stream; and wherein the periodic synchronization boundaries are DVB-H megaframe boundaries. In some embodiments, the ranging signals comprise at least one of: DVB-H cyclic prefixes; DVB-H scattered pilot signals; and DVB-H continuous pilot signals. In some embodiments, a location of the apparatus is determined based on the pseudorange between the apparatus and the transmitter of the wireless signal. In some embodiments, the ranging signal represents a transmitter identifier associated with a transmitter of the wireless signal, and wherein the apparatus further comprises: transmitter location means for determining a location of the transmitter of the wireless signal based on the transmitter identifier; and position means for determining a location of the apparatus based the location of the transmitter of the wireless signal and the pseudorange between the apparatus and the transmitter of the wireless signal. In some embodiments, the ranging signal includes a pseudorandom sequence; and wherein the pseudorandom sequence represents the transmitter identifier.

In general, in one aspect, an embodiment features a method comprising: receiving a wireless signal at an apparatus, wherein the wireless signal represents a transport stream of data, wherein the transport stream has periodic synchronization boundaries, and wherein the transport stream includes a plurality of ranging time slices each occurring at the same predetermined offset from a respective one of the periodic synchronization boundaries, and wherein each of the ranging time slices includes a ranging signal; and determining a pseudorange between the apparatus and the transmitter of the wireless signal based on the ranging signal.

Embodiments of the method can include one or more of the following features. In some embodiments, the transport stream is a Digital Video Broadcasting-Handheld (DVB-H) transport stream; and wherein the periodic synchronization boundaries are DVB-H megaframe boundaries. In some embodiments, the ranging signals comprise at least one of: DVB-H cyclic prefixes; DVB-H scattered pilot signals; and DVB-H continuous pilot signals. In some embodiments, a location of the apparatus is determined based on the pseudorange between the apparatus and the transmitter of the wireless signal. In some embodiments, the ranging signal represents a transmitter identifier associated with a transmitter of the wireless signal, and the method further comprises: determining a location of the transmitter of the wireless signal based on the transmitter identifier; and determining a location of the apparatus based the location of the transmitter of the wireless signal and the pseudorange between the apparatus and the transmitter of the wireless signal. In some embodiments, the ranging signal includes a pseudorandom sequence; and wherein the pseudorandom sequence represents the transmitter identifier.

In general, in one aspect, an embodiment features a computer-readable media embodying instructions executable by a computer to perform a method comprising: receiving a transport stream of data recovered from a wireless signal received by an apparatus, wherein the transport stream has periodic synchronization boundaries, and wherein the transport stream includes a plurality of ranging time slices each occurring at the same predetermined offset from a respective one of the periodic synchronization boundaries, and wherein each of the ranging time slices includes a ranging signal; and determining a pseudorange between the apparatus and the transmitter of the wireless signal based on the ranging signal.

Embodiments of the computer program can include one or more of the following features. In some embodiments, the transport stream is a Digital Video Broadcasting-Handheld (DVB-H) transport stream; and wherein the periodic synchronization boundaries are DVB-H megaframe boundaries. In some embodiments, the ranging signals comprise at least one of: DVB-H cyclic prefixes; DVB-H scattered pilot signals; and DVB-H continuous pilot signals.

In some embodiments, a location of the apparatus is determined based on the pseudorange between the apparatus and the transmitter of the wireless signal. In some embodiments, the ranging signal represents a transmitter identifier associated with a transmitter of the wireless signal, and the method further comprises: determining a location of the transmitter of the wireless signal based on the transmitter identifier; and determining a location of the apparatus based the location of the transmitter of the wireless signal and the pseudorange between the apparatus and the transmitter of the wireless signal. In some embodiments, the ranging signal includes a pseudorandom sequence; and wherein the pseudorandom sequence represents the transmitter identifier.

The details of one or more implementations are set forth in the accompanying drawings and the description below. Other features will be apparent from the description and drawings, and from the claims.

### DESCRIPTION OF DRAWINGS

FIG. 1 shows a communication system including a user terminal receiving SFN signals from a plurality of respective SFN transmitters in an SFN network according to one embodiment.

FIG. 2 shows detail of a DVB-H transmitter according to one embodiment.

FIG. 3 shows a process for the DVB-H transmitter of FIG. 2 according to one embodiment.

FIG. 4 shows an example DVB-H transport stream according to one embodiment.

FIG. 5 shows detail of a user terminal according to one embodiment.

FIG. 6 shows a process for the user terminal of FIG. 5 according to one embodiment.

The leading digit(s) of each reference numeral used in this specification indicates the number of the drawing in which the reference numeral first appears.

### DETAILED DESCRIPTION

Embodiments of the present invention achieve positioning with an SFN network by taking advantage of time-slicing, a feature in which a media program is broadcast in short bursts. Time-slicing is common to many of the recent SFN standards, such as DVB-H, MediaFLO, and T-DMB. Time-slicing is designed to improve the battery life of a mobile receiver by allowing the receiver's RF front-end and demodulator to be powered down outside the time slice(s) of interest.

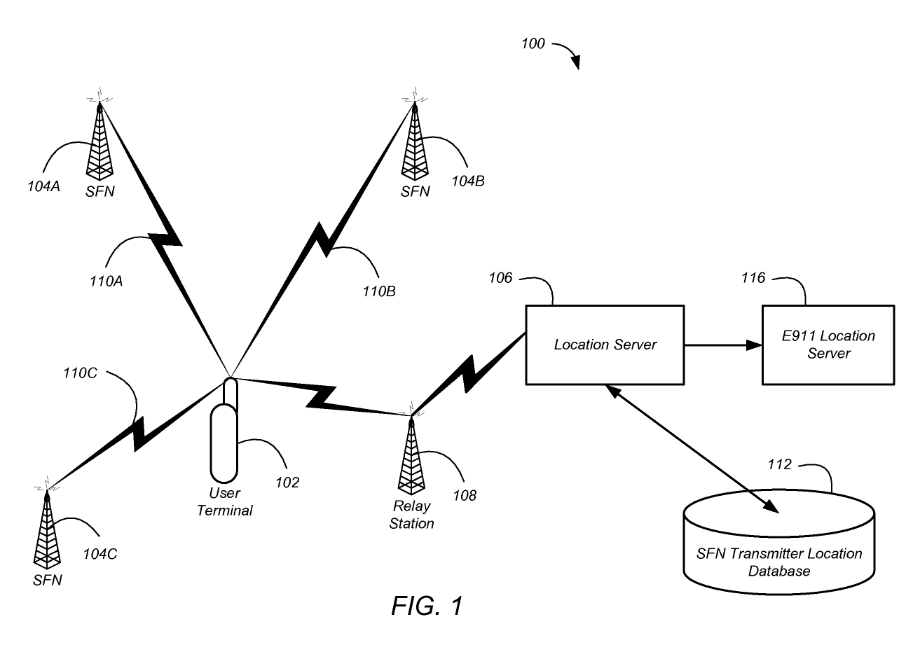

FIG. 1 shows a communication system 100 including a user terminal 102 receiving SFN signals 110A-C from a plurality of respective SFN transmitters 104A-C in an SFN network according to one embodiment. For example, SFN signals 110 can be DVB-H signals, ISDB-T signals, DAB signals ATSC-M/H signals, or the like. Although in the described embodiments, the elements of communication system 100 are presented in one arrangement, other arrangements are within the scope of the present invention. For example, elements of communication system 100 can be implemented in hardware, software, or combinations thereof.

The phrase “user terminal” is meant to refer to any object capable of implementing the pseudoranging techniques described herein. Examples of user terminals include PDAs, mobile phones, cars and other vehicles, and any object which could include a chip or software implementing the pseudoranging techniques described herein. Further, the term “user terminal” is not intended to be limited to objects which are “terminals” or which are operated by “users.”

In some embodiments, user terminal 102 performs the positioning techniques described herein. In other embodiments, some or all of the positioning techniques are performed by a location server 106 based on measurements collected by user terminal 102 and relayed by a relay station 108 such as a cellular base station and the like. The locations of SFN transmitters 104 can be stored in a SFN transmitter location database 112. The location of user terminal 102 can be transmitted to an E911 location server 116 for emergencies.

According to some embodiments, a “ranging” time slice is created that is exclusively or primarily used for positioning rather than multimedia delivery. In contrast to temporally spreading the ranging signal power over the entire duration of an signal as with a watermark, the ranging time slices are emitted in short bursts at regular intervals, utilizing the transmitter's full power. Such time slices are ignored by the receiver unless the receiver is performing a positioning operation. The ranging time slices are inserted into SFN signals 110 before broadcast.

In an SFN, satellite or terrestrial networks are frequently used to downlink the bitstream to individual base station transmitters. Since these are broadcast networks, it would be undesirable to define a scheme in which a separate transport stream must be distributed to each transmitter, each with a different ranging time slice. Instead, the ranging time slices can be generated locally at each SFN transmitter 104.

To ensure that the ranging time slice is inserted at the same position within the stream at all SFN transmitters 104, the ranging time slice inserters lock to a transport stream synchronization element. All SFN systems already utilize some sort of synchronization boundary or packet, such as the MIP (Megaframe Insertion Packet) for terrestrial DVB, the VFIP packet for A-VSB and the ISDB-T Information Packet. The ranging time slice inserter, therefore, ensures that the ranging time slice is installed at a desired offset within the framing structure delineated by these packets.

This approach not only ensures that all transmitters have time-synchronized ranging time slices, but also results in emission of a deterministic RF waveform, since the frame is designed such that the modulator state will always be consistent from one frame to another. As a consequence, the RF waveform that the receiver must correlate against will always be the same, regardless of when the ranging time slice inserter is started.

The ranging time slice techniques disclosed herein have multiple advantages as compared to watermark-based ranging systems. First, because the ranging signal need not be buried, its SNR (for a given amount of signal observation time) is increased markedly, as is the resistance to high near-far ratios, i.e. both increase by a factor equal to the bury ratio. Second, because the dominant signal has known structure, it can be subtracted from the received signal using interference cancellation techniques, improving near-far resistance even more. Third, because the ranging energy appears in short bursts with predictable arrival times, a mobile positioning receiver enjoys power-savings from a time sliced ranging signal in the same way that it benefits from time sliced media delivery. Fourth, since the signal power is delivered over a short time period, the channel is likelier to remain stationary during the signal collection, increasing the likelihood of successful coherent integration. Last, a flexible trade-off can be made between the percentage of time spent broadcasting the ranging time slice and other time slices, i.e. ranging duty cycle. Doubling the duration of a ranging time slice increases receiver sensitivity by a factor of 2 and improves resistance to near-far effects by a factor of 4. The repetition rate of the ranging time slice can also be changed to allow faster or slower position updates.

As an example of the benefit of using ranging time slices rather than ranging watermarks, consider a DVB-H signal where 1.5% of the system capacity is dedicated to a ranging time slice. Assuming 8 MHz bandwidth and ¼ guard interval, a ranging time slice would appear every 609.3 ms and be approximately 9 ms in duration. Since 9 ms is approximately 82,000 times T, the elementary period, the processing gain is 10·log(82,000) is ˜49 dB. The cross-talk rejection of two random sequences each of length 82,000 is about 38 dB. Depending on the channel impulse response, an additional 8 to 25 dB of cross-talk rejection can be obtained by successive or parallel cancellation techniques, for a total cross-talk rejection between 46 and 63 dB.

One approach to combating near-far effects is to employ a family of sequences with low cross-talk, i.e. a high ratio of auto-correlation peak power to cross-correlation peak power. Transmitters are then assigned a sequence within the family such that any that share the same sequence are as physically distant from each other as possible. Kasami short sequences, for example, achieve the theoretically minimal cross-talk for all relative timing offsets. LCZ (Low Correlation Zone) or ZCW (Zero Correlation Window) codes can be used for such purposes, in which the cross-correlation values are low-magnitude or zero, respectively, but only for relative shift values less than the anticipated delay spread of the received signal.

Any family of signals designed for minimal cross-correlation is very unlikely to also conform to the standardized signal pattern expected by a receiver and which is necessary to acquire and maintain lock on the signal. For example, DVB receivers rely on the presence of a cyclic prefix for symbol rate recovery and frequency estimation and also a pattern of continuous and scattered pilots for channel estimation. It might seem that the lack of such synchronizing elements is not problematic since the ranging time slice is only monitored by a receiver engaged in a positioning operation and is not necessarily intended to be demodulated into a digital bitstream, as the conventional time slices are. Therefore, it could be argued, such synchronizing elements can be safely omitted from the ranging signal.

However, this claim does not consider the effect on the program time slices that immediately follow the ranging time slice. Receivers must initiate acquisition some time prior to the start of time slice demodulation in order to allow the various control loops to settle. As an example, currently available DVB-H receivers require about 150 ms to settle before reception becomes reliable. Using that number as an example, assume that a ranging time slice with 1.5% duty cycle is inserted about once per second, i.e. a 9 ms duration ranging time slice. An additional 150 ms of dummy data would need to be placed after the 9 ms ranging time slice in order to allow the receiver to acquire the signal prior to demodulating the data in the conventional time slice. This would increase the effective overhead of the ranging time slice by more than 1600%.

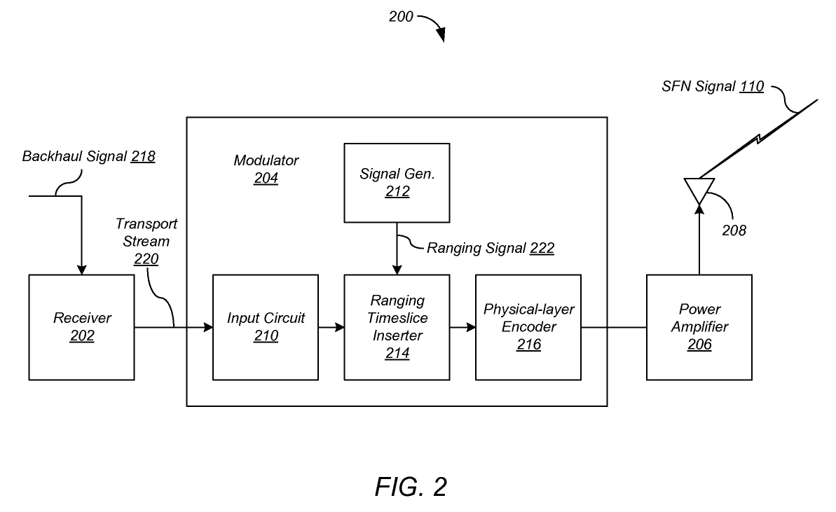

In some embodiments, SFN transmitters 104 of FIG. 1 are implemented as DVB-H transmitters. FIG. 2 shows detail of a DVB-H transmitter 200 according to one embodiment. Although in the described embodiments, the elements of DVB-H transmitter 200 are presented in one arrangement, other arrangements are within the scope of the present invention. For example, elements of DVB-H transmitter 200 can be implemented in hardware, software, or combinations thereof. In addition, while embodiments are described with respect to DVB-H signals, other SFN signals are within the scope of the present invention. Referring to FIG. 2, DVB-H transmitter 200 includes a receiver 202, a modulator 204, a power amplifier 206, and an antenna 208. Modulator 204 includes an input circuit 210, a signal generator 212, a ranging time slice inserter 214, and a physical-layer encoder 216.

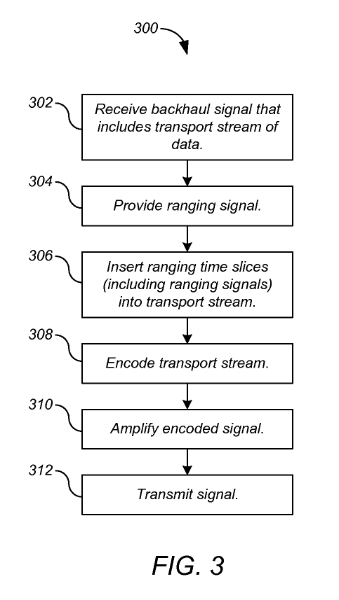

FIG. 3 shows a process 300 for DVB-H transmitter 200 of FIG. 2 according to one embodiment. Although in the described embodiments, the elements of process 300 are presented in one arrangement, other embodiments may feature other arrangements, as will be apparent to one skilled in the relevant arts based on the disclosure and teachings provided herein. For example, in various embodiments, some or all of the steps of process 300 can be executed in a different order, concurrently, and the like. In addition, while embodiments are described with respect to DVB-H signals, other SFN signals are within the scope of the present invention.

Referring to FIGS. 2 and 3, receiver 202 receives a backhaul signal 218 that includes a transport stream of data 220 (step 302). For example, receiver 202 can be a satellite receiver, and backhaul signal 218 can be a satellite downlink signal.

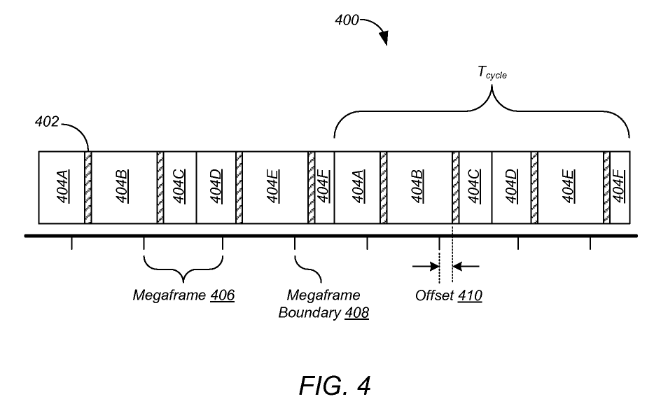

FIG. 4 shows an example DVB-H transport stream 220 according to one embodiment. Referring to FIG. 4, DVB-H signal 400 includes a sequence of program time slices 402, 404 that generally repeats every T_{cycle} seconds. T_{cycle} is configurable, and can be set for example at approximately 3 seconds. Each of program time slices 402, 404 is associated with one of a plurality of program identifiers (PID). Program time slices 404 are conventional program time slices each associated with one of a plurality of programs such as television programs. Program time slices 402, however, are reserved for use as ranging time slices.

DVB-H signal 400 is organized into a plurality of “megaframes” 406 each generally having a duration on the order of 500-800 ms. Megaframe boundaries 408 are locations in DVB-H signal 400 where the state of physical layer encoder 216 is known. Each ranging time slice 402 is located at the same offset 410 from a megaframe boundary 408.

Referring again to FIGS. 2 and 3, signal generator 212 of modulator 204 provides a ranging signal 222 (step 304). Ranging signal 222 represents a transmitter identifier of transmitter 200. Each transmitter 200 has a different transmitter identifier so that user terminals 102 can identify a transmitter based on a signal received from that transmitter.

In some embodiments, ranging time slices 402 are made to appear to resemble conventional program time slices 404 by retaining synchronization elements and signal structure necessary for a receiver to acquire or maintain lock on a signal. That is to say, each individual transmitter 200 emits a conformant RF signal during the ranging time slice, though they each emit a different conforming RF signal. In the context of DVB-H signaling, the cyclic prefix is present as are the scattered and continuous pilots. Only the data-bearing pilots would differ from one transmitter to another. Therefore, in some embodiments, ranging signal 222 includes at least one of the DVB-H cyclic prefixes, the DVB-H scattered pilot signals, and the DVB-H continuous pilot signals.

With this scheme, a demodulator that observed only a single transmitter during ranging time slice 402 could not trivially distinguish the resulting signal from a conventional one, i.e. one without a ranging time slice, whereas a demodulator that receives a combination of multiple transmitters could still achieve partial lock. As an example, a DVB-H demodulator that received signals from a combination of multiple SFN transmitters during the ranging time slice might experience a high rate of FEC errors, but the primary receiver control loops (frequency offset, symbol rate, and equalizer) would achieve full lock.

In some embodiments, ranging signal 222 includes a pseudorandom sequence which represents the transmitter identifier. For typical modulation schemes, this results in a uniform distribution among the k levels in a k-ary modulation scheme and generation of conformant synchronization signals. This approach allows use of unmodified modulator hardware.

The pseudorandom sequence must also be known to user terminals 102, thus allowing creation of a matched filter. User terminals 102 can generate these matched filters on demand, using knowledge of the pseudorandom sequence and known modulation parameters such as bandwidth, number of carriers, guard interval and the like.

Referring again to FIGS. 2 and 3, ranging time slice inserter 214 inserts ranging time slices into transport stream 220 (step 306). Each ranging time slice includes ranging signal 222. In DVB-H embodiments, ranging time slice inserter 214 replaces reserved program time slices 402 with the ranging time slices, for example according to the program identifiers. Therefore the ranging time slices occur at the same offset from megaframe boundaries 408 as reserved time slices 402.

In other embodiments, transport stream 220 may have other periodic synchronization boundaries. The periodic synchronization boundaries can be defined by a synchronization packet such as a DVB-H megaframe insertion packets, by some sort of synchronization mark in transport stream 220, or the like. In these embodiments, each ranging time slice is inserted at the same predetermined offset from a respective one of the periodic synchronization boundaries.

In some embodiments,, ranging time slice 402 includes guard periods at the beginning and end, which are the same for all SFN transmitters 104. The initial guard period insures that all previous program data is flushed from the demodulator in receiver 504 of user terminal 102 before the start of the transmitter-specific sequence. The final guard period insures that transmitter-specific data is flushed from the modulator prior to the resumption of the normal program data stream. The durations of the guard periods are determined by the structure of the modulator. For example, DVB-H the guard periods are each 12-14 MPEG packets in the transport stream, depending on the configuration of the modulator, with the actual time duration dependent on the bitrate of the modulator in the selected configuration.

After insertion of ranging time slices 402, physical layer encoder 216 encodes transport stream 220 (step 308). Power amplifier 206 amplifies the encoded signal (step 310), which is transmitted wirelessly by antenna 208 (step 312) as an SFN signal (FIG. 1).

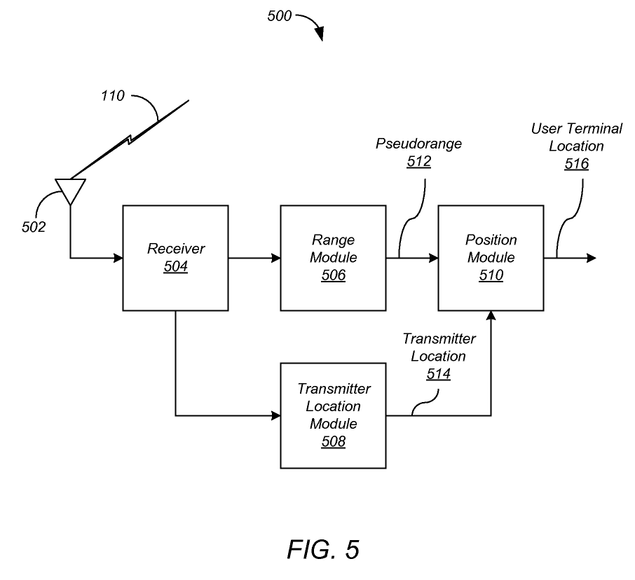

FIG. 5 shows detail of a user terminal 500 according to one embodiment. Although in the described embodiments, the elements of user terminal 500 are presented in one arrangement, other arrangements are within the scope of the present invention. For example, elements of user terminal 500 can be implemented in hardware, software, or combinations thereof. In addition, while embodiments are described with respect to DVB-H signals, other SFN signals are within the scope of the present invention.

Referring to FIG. 5, user terminal 500 includes an antenna 502, a receiver 504, a range module 506, a transmitter location module 508, and a position module 510. User terminal 500 can be used as user terminal 102 of FIG. 1.

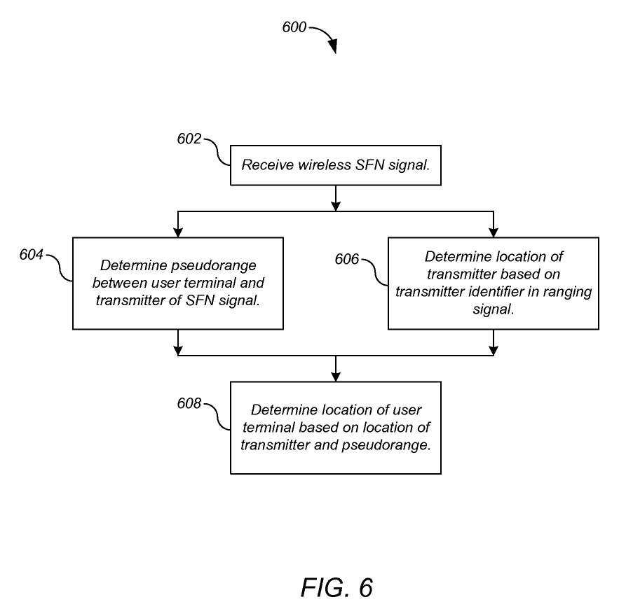

FIG. 6 shows a process 600 for user terminal 500 of FIG. 5 according to one embodiment. Although in the described embodiments, the elements of process 600 are presented in one arrangement, other embodiments may feature other arrangements, as will be apparent to one skilled in the relevant arts based on the disclosure and teachings provided herein. For example, in various embodiments, some or all of the steps of process 600 can be executed in a different order, concurrently, and the like. In addition, while embodiments are described with respect to DVB-H signals, other SFN signals are within the scope of the present invention.

Referring to FIGS. 5 and 6, receiver 504 of user terminal 500 receives a wireless SFN signal 110 via antenna 502 (step 602). Wireless SFN signal 110 represents transport stream 220 of FIG. 2. Range module 506 determines a pseudorange between user terminal 500 and the transmitter 104 of SFN signal 110 based on one or more of the ranging signals 222 in transport stream 220 (step 604). For example, in embodiments where ranging signal 222 includes a pseudorandom sequence, range module 506 determines the pseudorange based on the pseudorandom sequence.

A location of user terminal 500 can be determined based on the pseudorange when the location of the transmitter 104 of the SFN signal 110 is known. As described above, each ranging signal 222 represents a transmitter identifier associated with the transmitter 104 of ranging signal 222. Transmitter location module 508 determines a location of transmitter 104 based on the transmitter identifier in ranging signal 222 (step 606).

Position module 510 determines a location of user terminal 102 based on the location of transmitter 104 and the pseudorange (step 608). For example, position module 510 can determine the location of user terminal 102 based on measurements from multiple SFN signals 110, or using a combination of SFN signals 110 and other sorts of signals, including other terrestrial signals, satellite signals such as GPS, and the like.

In some embodiments, user terminal 102 maintains a database of transmitter characteristics, such as transmitter identifiers, antenna coordinates and the like. Although the almanac data should change relatively rarely, it can be broadcast on a regular basis to make user terminals 102 aware of modifications to the transmission network, such as new SFN transmitters 104 brought online, old SFN transmitters 104 decommissioned, changes to transmitter timing, and the like. In other embodiments, some or all of the data collected by user terminal 102 is relayed to location server 106 (FIG. 1), which determines the position of user terminal 102 in a similar manner.

Embodiments of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other implementations are within the scope of the following claims.

What is claimed is:

1. An apparatus comprising:
an input circuit to receive a transport stream of data, wherein the transport stream has periodic synchronization boundaries;
a signal generator to provide a ranging signal, wherein the ranging signal represents a transmitter identifier; and
a ranging time slice inserter to insert ranging time slices into the transport stream, wherein each ranging time slice is inserted into the transport stream at the same predetermined offset from a respective one of the periodic synchronization boundaries, and wherein each ranging time slice includes the ranging signal.

2. The apparatus of claim 1:
wherein the transport stream includes a plurality of program time slices each associated with one of a plurality of program identifiers, wherein the program time slices associated with a predetermined one of the program identifiers occur at the predetermined offset from the periodic synchronization boundaries; and
wherein the ranging time slice inserter replaces the program time slices associated with the predetermined one of the program identifiers with the ranging time slices.

3. The apparatus of claim 2:
wherein the transport stream is a Digital Video Broadcasting-Handheld (DVB-H) transport stream; and
wherein the periodic synchronization boundaries are DVB-H megaframe boundaries.

4. The apparatus of claim 3, wherein the ranging signals comprise at least one of:
DVB-H cyclic prefixes;
DVB-H scattered pilot signals; and
DVB-H continuous pilot signals.

5. The apparatus of claim 4:
wherein the ranging signal includes a pseudorandom sequence; and
wherein the pseudorandom sequence represents the transmitter identifier.

6. A modulator comprising the apparatus of claim 1.

7. A transmitter comprising the modulator of claim 6, wherein the transmitter is associated with the transmitter identifier.

8. An apparatus comprising:
input means for receiving a transport stream of data, wherein the transport stream has periodic synchronization boundaries;
signal generator means for providing a ranging signal, wherein the ranging signal represents a transmitter identifier; and
ranging time slice inserter means for inserting ranging time slices into the transport stream, wherein each ranging time slice is inserted into the transport stream at the same predetermined offset from a respective one of the periodic synchronization boundaries, and wherein each ranging time slice includes the ranging signal.

9. The apparatus of claim 8:
wherein the transport stream includes a plurality of program time slices each associated with one of a plurality of program identifiers, wherein the program time slices associated with a predetermined one of the program identifiers occur at the predetermined offset from the periodic synchronization boundaries; and
wherein the ranging time slice inserter means replaces the program time slices associated with the predetermined one of the program identifiers with the ranging time slices.

10. The apparatus of claim 9:
wherein the transport stream is a Digital Video Broadcasting-Handheld (DVB-H) transport stream; and
wherein the periodic synchronization boundaries are DVB-H megaframe boundaries.

11. The apparatus of claim 10, wherein the ranging signals comprise at least one of:
DVB-H cyclic prefixes;
DVB-H scattered pilot signals; and
DVB-H continuous pilot signals.

12. The apparatus of claim 11:
wherein the ranging signal includes a pseudorandom sequence; and
wherein the pseudorandom sequence represents the transmitter identifier.

13. A modulator comprising the apparatus of claim 8.

14. A transmitter comprising the modulator of claim 13, wherein the transmitter is associated with the transmitter identifier.

15. Computer-readable media embodying instructions executable by a computer to perform a method comprising:
receiving a transport stream of data, wherein the transport stream has periodic synchronization boundaries;
providing a ranging signal, wherein the ranging signal represents a transmitter identifier; and
inserting ranging time slices into the transport stream, wherein each ranging time slice is inserted into the transport stream at the same predetermined offset from a respective one of the periodic synchronization boundaries, and wherein each ranging time slice includes the ranging signal.

16. The computer-readable media of claim 15:
wherein the transport stream includes a plurality of program time slices each associated with one of a plurality of program identifiers, wherein the program time slices associated with a predetermined one of the program identifiers occur at the predetermined offset from the periodic synchronization boundaries; and
wherein inserting the ranging time slices into the transport stream includes replacing the program time slices associated with the predetermined one of the program identifiers with the ranging time slices.

17. The computer-readable media of claim 16:
wherein the transport stream is a Digital Video Broadcasting-Handheld (DVB-H) transport stream; and
wherein the periodic synchronization boundaries are DVB-H megaframe boundaries.

18. The computer-readable media of claim 17, wherein the ranging signals comprise at least one of:
DVB-H cyclic prefixes;
DVB-H scattered pilot signals; and
DVB-H continuous pilot signals.

19. The computer-readable media of claim 18:
wherein the ranging signal includes a pseudorandom sequence; and
wherein the pseudorandom sequence represents the transmitter identifier.

20. An apparatus comprising:
a receiver to receive a wireless signal, wherein the wireless signal represents a transport stream of data, wherein the transport stream has periodic synchronization boundaries, and wherein the transport stream includes a plurality of ranging time slices each occurring at the same predetermined offset from a respective one of the periodic synchronization boundaries, and wherein each of the ranging time slices includes a ranging signal; and
a range module to determine a pseudorange between the apparatus and the transmitter of the wireless signal based on the ranging signal.

21. The apparatus of claim 20:
wherein the transport stream is a Digital Video Broadcasting-Handheld (DVB-H) transport stream; and
wherein the periodic synchronization boundaries are DVB-H megaframe boundaries.

22. The apparatus of claim 21, wherein the ranging signals comprise at least one of:
DVB-H cyclic prefixes;
DVB-H scattered pilot signals; and
DVB-H continuous pilot signals.

23. The apparatus of claim 22:
wherein a location of the apparatus is determined based on the pseudorange between the apparatus and the transmitter of the wireless signal.

24. The apparatus of claim 23, wherein the ranging signal represents a transmitter identifier associated with a transmitter of the wireless signal, and wherein the apparatus further comprises:
a transmitter location module to determine a location of the transmitter of the wireless signal based on the transmitter identifier; and
a position module to determine a location of the apparatus based the location of the transmitter of the wireless signal and the pseudorange between the apparatus and the transmitter of the wireless signal.

25. The apparatus of claim 24:
wherein the ranging signal includes a pseudorandom sequence; and
wherein the pseudorandom sequence represents the transmitter identifier.

26. An apparatus comprising:
receiver means for receiving a wireless signal, wherein the wireless signal represents a transport stream of data, wherein the transport stream has periodic synchronization boundaries, and wherein the transport stream includes a plurality of ranging time slices each occurring at the same predetermined offset from a respective one of the periodic synchronization boundaries, and wherein each of the ranging time slices includes a ranging signal; and
range means for determining a pseudorange between the apparatus and the transmitter of the wireless signal based on the ranging signal.

27. The apparatus of claim 26:
wherein the transport stream is a Digital Video Broadcasting-Handheld (DVB-H) transport stream; and
wherein the periodic synchronization boundaries are DVB-H megaframe boundaries.

28. The apparatus of claim 27, wherein the ranging signals comprise at least one of:
DVB-H cyclic prefixes;
DVB-H scattered pilot signals; and
DVB-H continuous pilot signals.

29. The apparatus of claim 28:
wherein a location of the apparatus is determined based on the pseudorange between the apparatus and the transmitter of the wireless signal.

30. The apparatus of claim 29, wherein the ranging signal represents a transmitter identifier associated with a transmitter of the wireless signal, and wherein the apparatus further comprises:
transmitter location means for determining a location of the transmitter of the wireless signal based on the transmitter identifier; and
position means for determining a location of the apparatus based the location of the transmitter of the wireless signal and the pseudorange between the apparatus and the transmitter of the wireless signal.

31. The apparatus of claim 30:
wherein the ranging signal includes a pseudorandom sequence; and
wherein the pseudorandom sequence represents the transmitter identifier.

32. Computer-readable media embodying instructions executable by a computer to perform a method comprising:
receiving a transport stream of data recovered from a wireless signal received by an apparatus, wherein the transport stream has periodic synchronization boundaries, and wherein the transport stream includes a plurality of ranging time slices each occurring at the same predetermined offset from a respective one of the periodic synchronization boundaries, and wherein each of the ranging time slices includes a ranging signal; and
determining a pseudorange between the apparatus and the transmitter of the wireless signal based on the ranging signal.

33. The computer-readable media of claim 32:
wherein the transport stream is a Digital Video Broadcasting-Handheld (DVB-H) transport stream; and
wherein the periodic synchronization boundaries are DVB-H megaframe boundaries.

34. The computer-readable media of claim 33, wherein the ranging signals comprise at least one of:
DVB-H cyclic prefixes;
DVB-H scattered pilot signals; and
DVB-H continuous pilot signals.

35. The computer-readable media of claim 34:
wherein a location of the apparatus is determined based on the pseudorange between the apparatus and the transmitter of the wireless signal.

36. The computer-readable media of claim 35, wherein the ranging signal represents a transmitter identifier associated with a transmitter of the wireless signal, and wherein the method further comprises:
determining a location of the transmitter of the wireless signal based on the transmitter identifier; and
determining a location of the apparatus based the location of the transmitter of the wireless signal and the pseudorange between the apparatus and the transmitter of the wireless signal.

37. The computer-readable media of claim 36:
wherein the ranging signal includes a pseudorandom sequence; and
wherein the pseudorandom sequence represents the transmitter identifier.
